(19) United States
(12) Patent Application Publication
(10) Pub. No.: US 2008/0310834 A1
(43) Pub. Date: Dec. 18, 2008

(54) Camera Holding Device

(76) Inventor: Geane T. Chatman, II, Fort Washington, MD (US)

Correspondence Address: CAHN & SAMUELS LLP, 1100 17th STREET NW, SUITE 401, WASHINGTON, DC, 20036, US

(21) Appl. No.: 11/763,027

(22) Filed: Jun. 14, 2007

(51) Int. Cl. G03B 17/00; F16M 13/00

(52) U.S. Cl. 396/419; 248/158

(57) ABSTRACT

A holding device for a handheld photographic camera including a support member and coupling component that attaches to the camera enabling the user to securely hold the camera in one hand while using the other hand to control the functions of the camera. The support member also includes a camera mounting shoulder adjacent the coupling component that provides additional support to the camera. The support member includes various ergonomic contours that comfortably and securely fit within the user's hand. In some embodiments, the support member further includes a stand mount that allows the support member and camera to be attached to a camera stand, e.g. as a tripod or monopod, without the camera being detached from the support member.

### FIELD OF THE INVENTION

This invention relates generally to an apparatus for holding photographic devices. More particularly, the invention relates to an easy to use photographic camera holder that enables the secure handling, stabilization, and utilization of handheld cameras of all sizes.

### BACKGROUND OF THE INVENTION

Handheld cameras allow users to conveniently and portably capture images in a variety of locations and times. These images may then be utilized and enjoyed forever. The increased availability of digital cameras has spurred renewed enthusiasm in photography, particularly amongst amateur photographers. The rapid accessibility to high quality images and the availability of low cost models, making photography more accessible, are two of the contributing factors to this increased enthusiasm.

The increased popularity in photography and cameras, including film and digital versions of single-lens reflex (SLR) or digital single-lens reflex (DSLR), video, and camcorder models, has driven the photography industry to produce cameras that have higher resolutions and expanded features, e.g, more shooting condition controls, increased zoom functions, and larger LCD screens, all while making the overall cameras smaller and more lightweight. The decreased overall size also requires that the size of the control buttons be reduced and often crowded in limited available space. Because of this overall decreased size, larger screens, and the increased functions and corresponding control buttons in less available space, modern cameras are often difficult to securely handle, stabilize and use. This is particularly true when shooting while attempting to adjust the many functions or controls, or when shooting in fast-paced environments, as is often the situation.

FIG. 4A depicts an exemplary camera 70 for use with the present invention. Most cameras, film and digital, include a standard sized attachment couple 75 on the bottom base of the camera, as shown in FIG. 4B. The attachment couple 75 allows the camera 70 to be attached to a camera stand or mount, e.g. a tripod or monopod. Attachment to such a stand allows users to secure and/or stabilize the camera in certain shooting conditions, e.g. shooting portraits, shooting in windy or crowded conditions, shooting for extended periods, etc. that require more control over the camera. FIG. 5A illustrates an exemplary standard tripod 80 including an attachment couple 85. FIG. 5B illustrates an exemplary standard monopod 90 including an attachment couple 95. While tripods and monopods are useful as stationary shooting accessories, they are bulky and heavy and therefore not very mobile, easy to use, or practical in many shooting conditions.

Notwithstanding the usefulness of the above-described devices, a need still exists for an easy to use photographic camera holder that allows users to freely and dexterously handle, stabilize, and utilize handheld cameras of all sizes such that all the functions of the camera can be easily and readily used.

### SUMMARY OF THE INVENTION

In at least one embodiment this invention provides an apparatus for holding a photographic device, comprising a handheld support post; and a mounting member attached to said support post, wherein said mounting member is configured to engage and attach to a camera.

In at least one embodiment this invention provides a camera holder, comprising a handheld support post; a camera mounting shoulder disposed on an end of said support post; and a mounting screw disposed on said camera mounting shoulder, wherein said mounting screw is configured to attach to a camera.

In at least one embodiment this invention provides in combination, a camera support apparatus and camera, comprising a camera including a female receptacle; and a camera support apparatus, comprising a substantially cylindrical handheld member; and an attachment member disposed in an end of said handheld member configured to engage and attach to said female receptacle of said camera.

An objective of the invention is to provide a support for handheld cameras, including film and digital versions of SLR, DSLR, video, and camcorders, that allows users of all levels, including professional, hobbyist, and casual photographers, to easily and securely handle, stabilize and use cameras of all sizes.

An advantage of the invention is that users are better able to freely and dexterously handle cameras of all sizes, particularly very small or heavy models, in one hand while simultaneously controlling the functions of the camera with the other hand.

### BRIEF DESCRIPTION OF THE DRAWINGS

The present invention is described with reference to the accompanying drawings, wherein:

FIG. 1 illustrates an exemplary embodiment of the camera holding device in accordance with the present invention.

FIGS. 2A-2C illustrate alternative exemplary embodiments of the camera holding device in accordance with the present invention.

FIGS. 3A-3D illustrate alternative exemplary embodiments of the camera holding device in accordance with the present invention.

FIGS. 4A-4B illustrate an exemplary prior art camera for use with the present invention.

FIGS. 5A-5B illustrate exemplary prior art camera stands for use with the present invention.

Given the following enabling description of the drawings, the apparatus should become evident to a person of ordinary skill in the art.

### DETAILED DESCRIPTION OF THE DRAWINGS

The present invention includes a camera holding device 10 that allows a user to securely and reliably handle, stabilize and use a handheld camera. Particularly, the camera holding device 10 allows users to securely and stably hold the camera in one hand while adjusting the camera's utilities with the other hand. This function is particularly useful when using smaller and/or heavier camera models that are often difficult to handle.

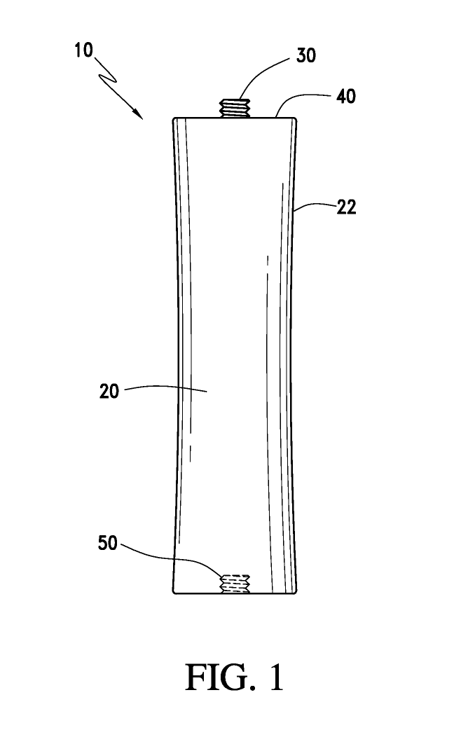

As illustrated in FIG. 1, camera holding device 10 includes a support post 20 and a mounting member 30. The support post 20 is preferably made of a lightweight material, such as plastic, natural or synthetic wood, alloys, etc., and is designed to be held in the hand of a user. The support post 20 may also include a camera mounting shoulder 40 on an end of the support post 20 adjacent to mounting member 30. It is desirable for mounting member 30 to be compatible with all commercially available cameras. Many such cameras include a threaded female receptacle intended for securing the camera to a tripod or monopod. Accordingly, in some embodiments, the mounting member 30 may be a standard sized threaded bolt, e.g. a ⅜ inch male bolt, that protrudes from an end of the support post 20. The mounting member 30 is inserted and screwed into the female receptacle (pod or stand mount) found on the bottom of most cameras to secure the camera holding device 10 to the camera. The camera mounting shoulder 40 provides additional stability and security for the camera by blocking the user's hand from bumping against the camera.

In other embodiments, for cameras having non-threaded female receptacles, a mounting member 30 may comprise a male post or punch configured to securely engage the camera's receptacle. The support post 20 may also include an optional stand mount 50 for receiving a mounting component of a camera stand, e.g. a tripod or monopod. The stand mount 50 allows the camera to be quickly and easily mounted on a camera stand without removing the camera from the camera holding device 10. The stand mount 50 thereby provides increased functionality and flexibility of use of the camera holding device 10 and camera.

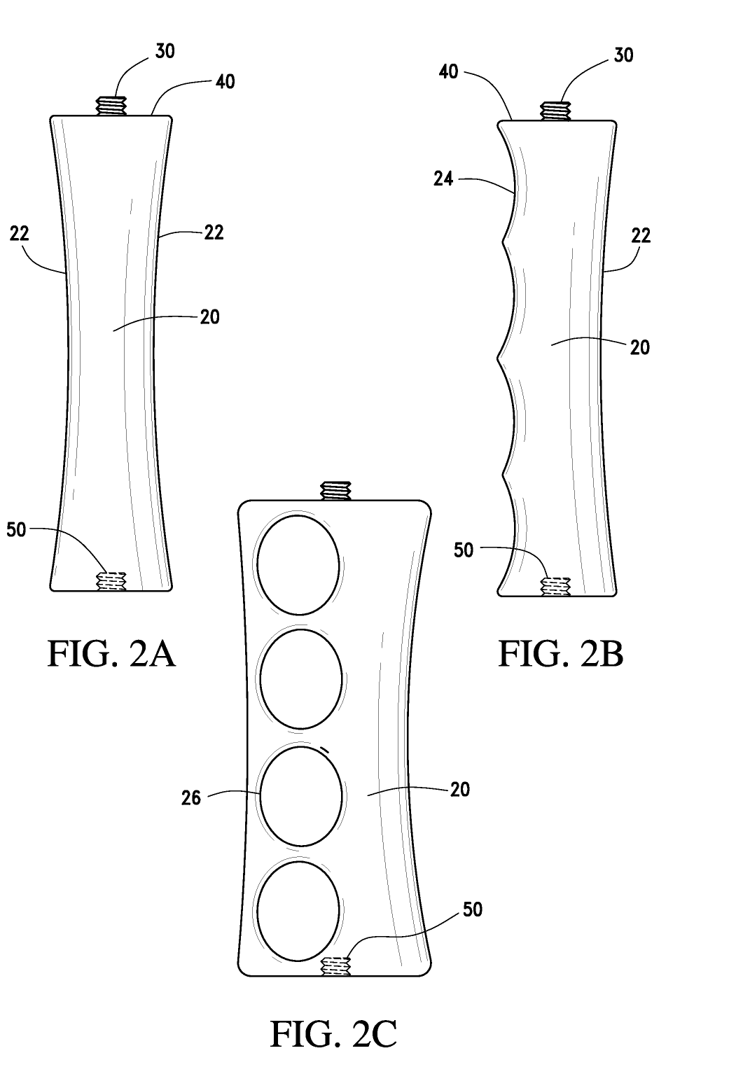

As illustrated in FIGS. 2A-2C, the support post 20 may also include contours, e.g. streamlined, handle-grip, finger-slots, and other ergonomic contours, along the surface that allow for a more comfortable and secure grip in the hand of a user. FIG. 2A illustrates a support post 20 having a streamlined contours 22. FIG. 2B illustrates a support post 20 having a streamlined contour 22 and a handle-grip contour 24. FIG. 2C illustrates a support post 20 having a finger-slot contour 26. The various support post contours may be combined to yield still other contour combinations depending on user requirements and preferences.

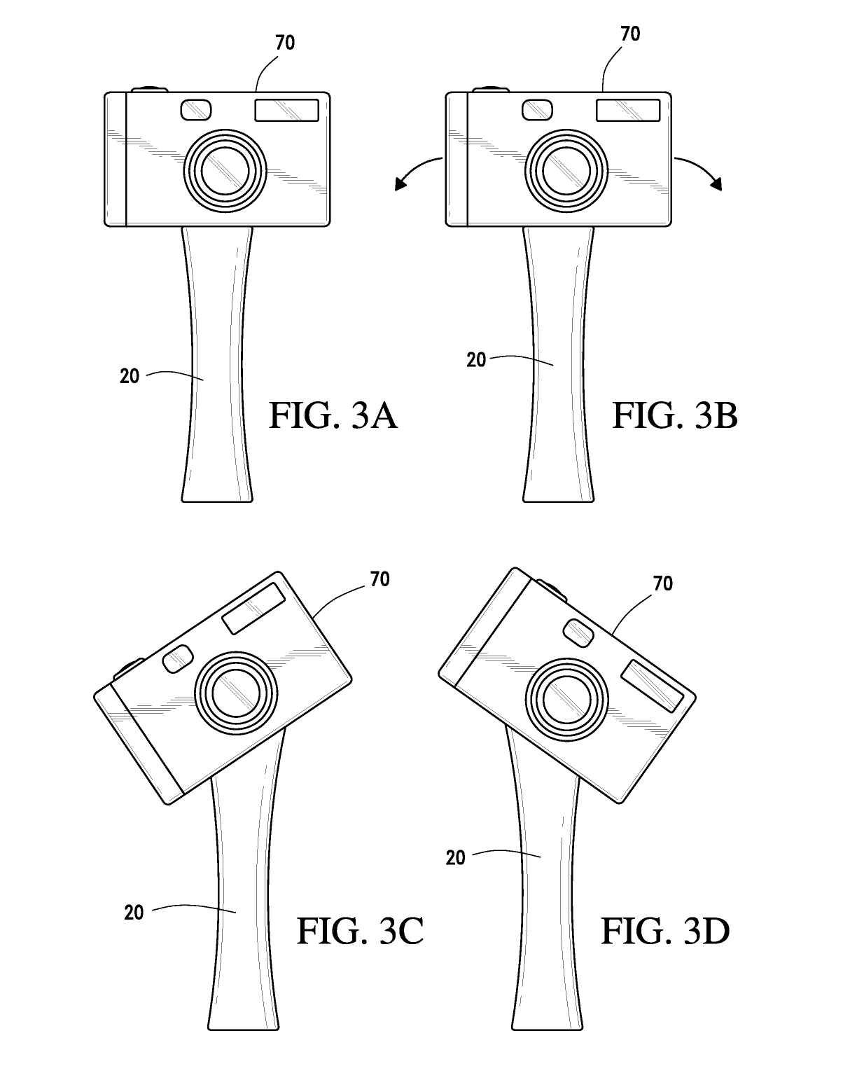

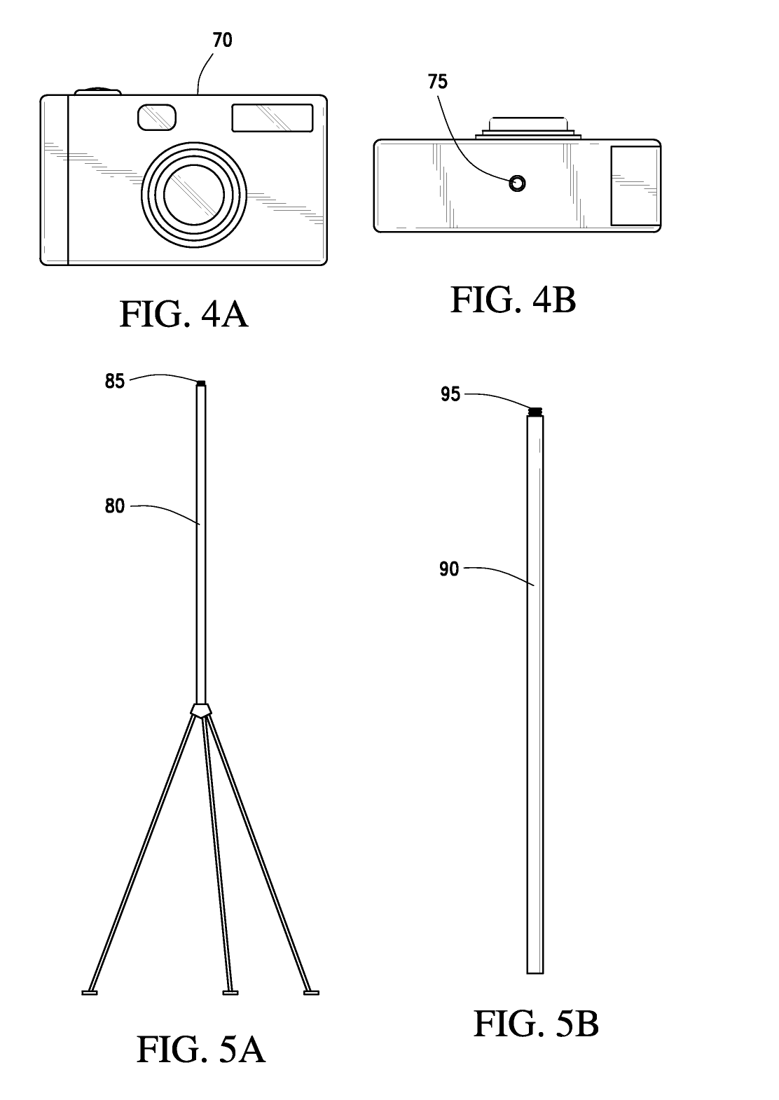

As illustrated in FIGS. 3A-3D, the mounting member 30 may also pivot along vertical and horizontal axes of support post 20. FIG. 3A illustrates a camera 70 mounted on the support post 20 of the camera holding device 10 via the mounting member 30. FIG. 3B illustrates that the mounting member 30 and camera 70 are capable of pivoting in either direction along a vertical axis of support post 20. FIGS. 3C and 3D illustrate the camera 70 pivoted in opposite directions along a vertical axis of support post 20. The pivot may be designed to quickly adjust to selected angles, for example in increments of 5 or 10 degrees. The pivoting of the mounting member 30 provides the user with additional flexibility of use by, for example, allowing the user to consistently capture images from the same perspective, incrementally change the perspective and juxtapose the perspective, etc.

The present invention assists the user in holding the camera steady while shooting thus leading to photographs with minimal blur caused by “camera shake”.

It should be noted that the present invention may be embodied in many different forms and should not be construed as limited to the embodiments set forth herein. Rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. An apparatus for holding a photographic device, comprising:
a handheld support post; and
a mounting member attached to said support post, wherein said mounting member is configured to engage and attach to a camera.

2. The apparatus according to claim 1, wherein said support post includes a camera mounting shoulder adjacent said mounting member.

3. The apparatus according to claim 1, wherein said support post includes a stand mount on an end opposite said mounting member.

4. The apparatus according to claim 1, wherein said support post further comprises contours along the surface.

5. The apparatus according to claim 4, wherein said contours include at least one of handle-grip and finger-slot contours.

6. The apparatus according to claim 1, wherein said mounting member includes a mounting screw.

7. The apparatus according to claim 6, wherein said mounting screw pivots at selected angles.

8. A camera holder, comprising:
a handheld support post;
a camera mounting shoulder disposed on an end of said support post; and
a mounting screw disposed on said camera mounting shoulder, wherein said mounting screw is configured to attach to a camera.

9. The apparatus according to claim 8, wherein said support post includes a stand mount on an end opposite said mounting screw.

10. The apparatus according to claim 8, wherein said mounting screw pivots.

11. The apparatus according to claim 8, wherein said mounting screw pivots at selected angles.

12. The apparatus according to claim 8, wherein said support post includes contours along the surface.

13. The apparatus according to claim 12, wherein said contours include at least one of handle-grip and finger-slot contours.

14. In combination, a camera support apparatus and camera, comprising:
a camera including a female receptacle; and
a camera support apparatus, comprising:
a substantially cylindrical handheld member; and
an attachment member disposed in an end of said handheld member configured to engage and attach to said female receptacle of said camera.

15. The apparatus according to claim 14, wherein said handheld member includes a shoulder adjacent said attachment member.

16. The apparatus according to claim 14, wherein said handheld member includes a stand mount on an end opposite said mounting screw.

17. The apparatus according to claim 14, wherein said handheld member includes contours along the surface.

18. The apparatus according to claim 17, wherein said contours include at least one of a handle-grip and finger-slot contours.

19. The apparatus according to claim 14, wherein said attachment member includes a mounting screw.

20. The apparatus according to claim 19, wherein said mounting screw pivots at selected angles.
